(19) United States
(12) Patent Application Publication
(10) Pub. No.: US 2014/0265256 A1
(43) Pub. Date: Sep. 18, 2014

(54) SYSTEMS AND METHODS FOR MOVING PEOPLE

(71) Applicants: Polly Rothstein, Purchase, NY (US); Chester Rothstein, Rye, NY (US)

(72) Inventors: Polly Rothstein, Purchase, NY (US); Chester Rothstein, Rye, NY (US)

(21) Appl. No.: 13/795,553

(22) Filed: Mar. 12, 2013

(51) Int. Cl. B62B 7/06

(52) U.S. Cl. CPC B62B 7/06
USPC 280/651

(57) ABSTRACT

The invention generally relates to people movers fabricated from at least two frame assemblies pivotably connected, for example, in a v formation, wherein the forward end of each frame assembly is pivotably connected such that the rearward end of each frame assembly can be at a variable offset distance so the overall width of the people mover can be adjusted from a maximum (widest) overall width to a minimum (substantially narrow) overall width. Further, the frame assemblies can include forward wheel(s) and/or rearward wheel(s) that can roll in any direction and/or in a regulated range of directions such that when the people mover is at its maximum (widest) width the rearward wheels can only roll in a forward and/or inwardly direction and when the people mover is at its minimum (substantially narrow) width the rearward wheels can only roll in a substantially forward and/or substantially outwardly direction.

### FIELD

The present invention relates to systems and methods for moving people that include enhanced width variability.

### BACKGROUND

Numerous devices exist for moving people. For example, strollers can be used to move children. As another example, walkers and/or rollators can be used by disabled and/or elderly people who may need additional support to maintain balance and/or stability while walking.

Some of these devices allow for varying the dimensions of the structure. For example, some strollers can be collapsed for storage. Further, some of these devices can allow for width variation during use. For example, referring to FIGS. 7A-7B, one such rollator is disclosed in U.S. Pat. No. 7,866,677, filed Oct. 27, 2009, the contents of which are incorporated herein in its entirety. The above rollator does allow for, amongst other things, width variation during use; however, to enable width variation the above rollator utilizes struts which are pivotally engaged at both ends, on one end at or near a rear wheel assembly and at or near the main pivot to wheel assemblies such that the angle at which lower the support members are splayed determines the alignment of the rear wheels and thus the possible direction of travel.

Although these struts do, amongst other things, provide the above benefit of allowing variable width during use, potential negative implications of such strut is that it can act as and/or create a point of structural weakness, become bent due to a load on it, get caught on external objects, get out of alignment, and/or there may be more cost effective solutions which can provide the same, if not substantially better, benefits as well as others.

### SUMMARY

In exemplary embodiments, systems and methods for moving people can comprise a first frame assembly, can have at least one forward end, and at least one rearward end, and at least one vertical riser, and/or at least one horizontal runner. The at least one first frame assembly can be coupled to at least one forward wheel and/or an at least one rearward wheel. Further a second frame assembly can have an at least one forward end, an at least one rearward end, an at least one vertical riser, and/or an at least one horizontal runner, the at least one second frame assembly can be coupled to at least one forward wheel and/or an at least one rearward wheel.

Further still, least one width variator can pivotably couple the forward ends of at least the first frame assembly and/or the second frame assembly such that, for example, the offset distance between at least the rearward ends of the first frame assembly and the second frame assembly can be adjustable.

In exemplary embodiments, a first rearward wheel regulator can regulate the amount of swivel or swivel range of the first rearward wheel coupled to the first frame assembly. Further, a second reward wheel regulator can regulate the amount of swivel or swivel range of the second rearward wheel coupled to the second frame assembly. Further, during adjustment of the offset set distance between the rearward ends of the first frame assembly and the second frame assembly, the wheel regulators may regulate the swivel of the rearward wheels such that the people mover does not traverse laterally.

In exemplary embodiments, a forward wheel regulator may regulate the swivel range of at least the forward wheel allowing the forward wheel to swivel through a substantially a 360° range or to swivel through a limited swivel range.

In exemplary embodiments the rearward wheel regulators can each enable at least one rearward wheel to pivot through an at least one rearward regulated swivel range so, for example, the at least one rearward wheel can regulatedly roll through an at least one regulated range of directions.

In exemplary embodiments, the forward wheel can freely roll in any direction.

In exemplary embodiments when the at least one offset distance between the at least one rearward ends of the at least one first frame assembly and second frame assembly are its largest offset distance, the at least one rearward wheel regulator regulates the swivel of the rearward wheels such that the rearward wheels can only roll in a substantially forward direction or a substantially inwardly direction. Further, in exemplary embodiments, the inwardly direction can be at any angle between 0 degrees to about 60 degrees off the at least one forward direction.

In exemplary embodiments, when the offset distance between at least the rearward ends of the at least one first frame assembly and the second frame assembly are its smallest offset distance the at least one rearward wheel regulators regulate the swivel of the rearward wheels such that the rearward wheels can only roll in a substantially outwardly direction. Further, the outwardly direction can be at any angle between 0 degrees to about 60 degrees outward from the forward direction.

In exemplary embodiments, at least one of the rearward wheel regulators can further comprise a blocking pin that can regulate the swivel range by blocking movement of the at least one rearward wheel beyond the at least one swivel range/angle.

In exemplary embodiments, at least one of the rearward wheel regulators can further comprise an elastically deforming mechanism that can regulate the swivel range by elastic deformation, hindering movement of the at least one rearward wheel beyond the at least one swivel range. Further, in exemplary embodiments, at least one impeding mechanism can be any one of an spring, a bending member, and a compression member.

In exemplary embodiments, at least one of the rearward wheel regulators can further comprise a slot, finger, and/or groove that can regulate the at least one swivel range by hindering movement of the at least one wheel beyond the at least one regulated swivel range/angle.

In exemplary embodiments, the system and methods for moving people can further comprise a braking mechanism and/or an user interface including at least one braking mechanism interface and/or an at least one supporting mechanism interface. Further, a braking mechanism may lock the swivel of the rearward wheels.

In exemplary embodiments, the system for moving people can further comprise a collapsing mechanism such that the overall height of the system for moving people can be capable of substantially decreasing for storage and/or increasing and/or decreasing the variable height for various users. Further, in exemplary embodiments, the collapsing mechanism can be least a telescoping mechanism.

In exemplary embodiments, at least one of the rearward wheel regulators, can regulatedly limit the swivel range of one of the rearward wheels without the use of a strut assembly.

In exemplary embodiments, the at least one rearward wheel regulator can further comprise springs that can restrict the rearward wheels such that they remained aligned to roll straight when going in reverse.

In exemplary embodiments, the at least one rearward wheel regulator can further comprise at least one of a groove and/or channel that can restrict the rearward wheels such that they remained aligned to roll straight when going in reverse.

In exemplary embodiments, the at least one rearward wheel regulator can further comprise a manual lock, for example, activated by a user interface that can restrict the rearward wheels such that they remain aligned to roll straight when rolling in at least one of a reverse direction and forward direction.

In exemplary embodiments, at least one rearward wheel regulator can further comprise a spring that restricts the rearward wheels such that they remained aligned to roll straight when rolling in a reverse and/or a forward direction.

In exemplary embodiments, the first and second frame assembly may each further comprise a horizontal runner.

Further, in exemplary embodiments, each of the rearward wheels may be a castor wheel.

### BRIEF DESCRIPTION OF THE DRAWINGS

The features and advantages of the present invention will be more fully understood with reference to the following, detailed description when taken in conjunction with the accompanying figures, wherein:

FIGS. 1A-1C are illustrative depictions of exemplary people movers, in accordance with exemplary embodiments of the present invention;

FIG. 2A is a front view illustratively depicting an exemplary people mover, in accordance with exemplary embodiments of the present invention;

FIG. 2B is a rear view illustratively depicting an exemplary people mover, in accordance with exemplary embodiments of the present invention;

FIG. 2C is a side view illustratively depicting an exemplary people mover, in accordance with exemplary embodiments of the present invention;

FIG. 2D is an opposite side view illustratively depicting an exemplary people mover, in accordance with exemplary embodiments of the present invention;

FIG. 2E is a top view illustratively depicting an exemplary people mover, in accordance with exemplary embodiments of the present invention;

FIG. 2F is bottom view illustratively depicting an exemplary people mover, in accordance with exemplary embodiments of the present invention;

FIGS. 3A-3D illustratively depict width variation of exemplary people movers, in accordance with exemplary embodiments of the present invention;

FIGS. 4A-4E illustratively depict exemplary wheels pivoting and/or width variation of exemplary people movers pivoting through exemplary swivel ranges, in accordance with exemplary embodiments of the present invention;

FIG. 5 illustratively depicts an exemplary wheel regulator of exemplary people movers, in accordance with exemplary embodiments of the present invention;

FIG. 6 illustratively depicts an exemplary collapsing mechanisms of exemplary people movers, in accordance with exemplary embodiments of the present invention;

FIGS. 7A-7B illustratively depict an exemplary rollator that uses struts, the contents of which are incorporated herein in its entirety.

### DETAILED DESCRIPTION

The invention generally relates to people movers fabricated from at least two frame assemblies pivotably connected, for example, in a V formation, wherein the forward end of each frame assembly pivotably connect such that rearward end of each frame assembly can be at a variable offset distance so the overall width of the people mover can be adjusted from a maximum (widest) overall width to a minimum (substantially narrow) overall width. Further, the frame assemblies can include forward wheel(s) and/or rearward wheel(s) that can swivel and/or roll in any direction and/or in a regulated range of directions such that when the people mover is at its maximum (widest) width the swivel of the rearward wheels is limited so that the rearward wheels can only roll in a forward and/or inwardly direction and when the people mover is at its minimum (substantially narrow) width the rearward wheels can only roll in a forward and/or outwardly direction.

Referring to FIGS. 1A-1C, in exemplary embodiments, various exemplary people movers 100 are illustrated that can include a first frame assembly 102 and a second frame assembly 104 and that can be pivotably connected by a width variator 106 such that, as described herein, the overall width of people mover 100 can be controlled by a user.

Further, discussed herein in greater detail, people mover 100 can include a forward wheel regulator 112 and/or a rearward wheel regulator 114 enabling forward wheel(s) 108 and/or rearward wheel(s) 110 to pivot/swivel through a regulated swivel range. This, in turn, enables forward wheel(s) 108 and/or rearward wheel(s) 110 to roll through a regulated range of directions.

It will be understood that people movers 100 can be any form of walker, rollator, stroller, pusher, and/or any other object capable of varying the objects overall width as well as being capable of having the forward wheel(s) rolling in a first direction and the rearward wheels pivot being regulated independently and/or without being regulated by the direction that the forward wheel(s) roll through. For ease, at times, only a rollator is described. This is merely for ease and is in no way meant to be a limitation.

By way of example, referring to FIGS. 2A-2F, exemplary people mover 100 is illustratively depicted as a rollator that can include a first frame assembly 102 and a second frame assembly 104 that are pivotably connected by a width variator 106 as well as include forward wheel(s) 108 that can roll in a first direction and rearward wheel(s) 110 that can pivot and/or roll through a regulated range of directions independent from forward wheel(s) 108.

Further, in exemplary embodiments, people mover 100 can include a first frame assembly 102 and a second frame assembly 104 that can both include a vertical riser 202 and/or horizontal runner 204. Further still, in exemplary embodiments, people mover 100 can include user interface 206 that can include supporting member interface 208 that can support a user's arms/hands/etc. when using people mover 100 and/or braking mechanism interface 210 that can be used to engage with a braking mechanism 211.

In exemplary embodiments, vertical riser 202 can include a height adjustor 212 that can be used to adjust the height of people mover 100 for a user. These height adjustments can set the overall height of people mover 100 and/or set the height of user interface 206 so that that a user being supported by supporting member interface 208 and/or interfacing with braking mechanism interface 210 is, for example, comfortable. Further, supporting mechanism interface 208 can be angled to, amongst other things, increase blood circulation through the user's arms.

In exemplary embodiments, people mover 100 can include hand brakes 210 that can be mounted, for example, on the top of the frame, for example, at user interface 206, such that a user can activate brakes 211 with substantial ease.

Further, in exemplary embodiment, forward wheel(s) 108 and/or rearward wheel(s) 110 can restrictively pivot through a regulated swivel range such that when in motion along a straight line, they tend to automatically align to, and rotate parallel to the direction of travel. A consequence of this is that people mover 100 may, in some instances, tend to travel in a straight direction.

Referring to FIGS. 3A-3D, in exemplary embodiments, people mover 100 can be constructed such that overall width “W” of the people mover can vary. For example, people mover 100 can include first frame assembly 102 and second frame assembly 104 that can be pivotably connected by a width variator 106 such that the overall width of people mover 100 can be controlled by a user. In exemplary embodiments, width variator 106 can pivotably connect first frame assembly 102 and second frame assembly 104 via any form of pivot joint, such as, but not limited to, a ball and socket joint, a condyloid (Ellipsoid) joint, a saddle joint; a hinge joint; a revolute joint (“pin” and “hinge”), a prismatic joint (“slider”), a cylindrical joint, a screw joint, a planar joint, a joint utilizing cams and/or gears, any combination or separation thereof, and/or any other reasonable type of mechanism capable of varying the overall width of people mover 100.

Further, referring to FIGS. 4A-4E, in exemplary embodiments, people mover 100 can include forward wheel(s) 108 and rearward wheel(s) 110 that can roll in various directions substantially independently from each other and/or the direction that rearward wheel(s) 110 rolls through need not be regulated by the direction that forward wheels 106 roll through. For example, forward wheel(s) 108 can freely swivel, through a forward swivel range “α” such that forward wheel(s) 108 can roll in a first direction and rearward wheel(s) 110 can restrictively swivel through a rearward swivel range “β” such that they can roll in a second direction.

Still referring to FIGS. 4A-4D, in exemplary embodiments, having either a forward wheel(s) 108 swivel freely and/or restrictively swivel in conjunction with rearward wheel(s) 110 only being able to restrictively swivel, the lateral travel of the people mover 100 can be regulated enough to still remain safe while maintaining width variability. By way of example, in exemplary embodiments, this can reduce the risk of people mover from traversing laterally, traversing in an uncontrolled direction, and/or traversing in an undesired direction that may increase the risk of falling and/or injury.

By way of example, referring to FIGS. 4A-4D, the frame assemblies can include forward wheel(s) that can roll in any direction, for example, through a swivel range “α”, and/or a restrict range of directions (not shown) and rearward wheels that can roll in a regulated range of directions, for example, through a rearward swivel range “β”, such that that when the width of people mover is at its maximum (widest) the rearward wheels can only roll forward and/or in an inwardly direction. For example, the rearward swivel range “β” can limited to about 60 degrees off center.

By way of example, FIGS. 4A and 4B illustrates when the frame assemblies are at or near their widest separation, and therefore the swivel of the rearward wheels are depicted as being restricted/limited to an inwardly type swivel. In other words, the forward wheels may roll in any direction, for example, through a forward swivel range “α”, and/or a restricted range of directions (not shown). The rearward wheels may only roll in regulated range of directions governed by the rearward swivel range “β”, such that that when the width of the people mover is at or near its maximum width, the rearward wheels can only roll forward and/or in an inwardly direction.

Similarly FIGS. 4C and 4D illustrate when the frame assemblies are at or near their smallest or least separation, and therefore the swivel of the rearward wheels are depicted as being restricted/limited to an outwardly type swivel. In other words, the forward wheels may again roll in any direction, for example, through a forward swivel range “α”, and/or a restricted range of directions (not shown). The rearward wheels may only roll in regulated outward range of directions governed by the rearward swivel range “β”, such that that when the width of the people mover is at or near its minimum width, the rearward wheels can only roll forward and/or in an outwardly direction.

In exemplary embodiments, forward wheel(s) 108 can freely swivel, as shown in FIGS. 4A-4D, through a forward swivel range “α” by way of example, forward wheel(s) 108 can roll freely in a first direction because forward wheel(s) 108 can be a castor wheel. For example, forward wheel(s) 108 can be an un-driven, single, double, and/or compound wheel(s) that can be constructed of rubber, plastic, nylon, aluminum, and stainless steel. By way of example, forward wheel(s) 108 can be a wheel(s) mounted to a mount such as, but not limited to, a fork with a swivel joint coupled to the fork, a swivel joint coupled to a fork, and/or any other configuration that can allow forward wheel(s) 108 to freely rotate about 360°, enabling the wheel(s) to roll in any direction.

In exemplary embodiments, as discussed, the wheels (e.g., the forward and/or rearward wheels) may be swivel castor wheels. A swivel caster can include a small amount of offset distance between the center axis of the vertical shaft and the center axis of the caster wheel, so as when the caster is moved and the wheel is not facing the “correct” direction, the offset can cause the wheel to rotate/swivel around the axis of the vertical shaft to follow behind the direction of movement. If there is no offset, the caster wheel will not swivel/rotate if it is not facing the correct direction and may prevent motion or cause dragging across the ground or surface. However, when a swivel castor wheel is in motion along a straight line, the swivel caster wheels can tend to automatically align to, and rotate/swivel parallel to the direction of travel.

It will be understood that swivel regulation mechanism can use any technique for regulation of the swivel range and/or direction that forward wheel(s) 108 and/or rearward wheels can swivel and/or roll through, for example, independently of each other. For example, wheel regulator 112/114 can regulate the swivel range and/or direction that forward wheel(s) 108 and/or rearward wheels can swivel and/or roll through using any form of mechanical regulator, electro-mechanical regulator, chemical regulator, pressure driven regulator, any combination and/or further separation thereof, and/or any reasonable technique for regulating.

By way of example, referring to FIG. 5, in exemplary embodiments, forward wheel(s) 108 and/or rearward wheel(s) 110 can swivel through a regulated swivel range α/β using an wheel regulator 112/114 that can include impeding and/or deforming mechanisms(s) 510 that substantially define the range that forward wheel(s) 108 and/or rearward wheel(s) 110 can swivel through a regulated swivel range α/β. For example, mechanism(s) 510 can act as a barrier defining the swivel range α/β.

In exemplary embodiments, mechanism(s) 510 can be designed to substantially block movement of the wheel(s) and/or wheel assembly beyond the swivel range. Further, in exemplary embodiments, mechanism(s) 510 can be designed to elastically deform hindering movement of the wheel(s) beyond the swivel range. Further still, in exemplary embodiments, mechanism(s) 510 can impede movement of the wheel(s) and/or wheel assembly beyond the swivel range using a spring, a bending member, a compression member, slot, finger, groove, any combination or separation thereof, and/or any other reasonable mechanism.

Further, in exemplary embodiments, forward wheel(s) 108 and/or rearward wheel(s) 110 can be a wheel(s) mounted to mount with an wheel regulator mechanism such as, but not limited to, a fork with swivel joint coupled to the fork, and/or any other configuration that allows forward wheel(s) 108 and/or rearward wheel(s) 110 to rotate through a regulated swivel range, enabling the wheel(s) to roll in a regulated direction.

Further still, in exemplary embodiments, the wheel regulator mechanism can maintain rearward wheel(s) 110 straight when going in reverse by, for example, using a spring, a bending member, a compression member, slot, finger, groove, any combination and/or separation thereof, and/or any other reasonable mechanism.

In exemplary embodiments, the wheel regulator mechanism can be user controlled, for example, such that the user can control that swivel range. For example, the wheel regulator mechanism can include pins that can be moved and/or activated (e.g., actively moved by the user, passively moved and/or activated based directional movement, etc.) for example, by drop pins into a position causing the rearward wheel(s) 110 to have varying degrees of swivel. By way of example, a pin can drop such that the rearward wheel(s) 110 have full rotation.

In exemplary embodiments, the wheel regulator mechanism can include springs that can restrict the rearward wheel(s) 110 such that they remain aligned to roll straight when going in reverse.

Further, in exemplary embodiments, the wheel regulator mechanism can include groove(s) and/or channel(s) that can restrict the rearward wheel(s) 110 such that they remain aligned to roll straight when going in reverse.

Further, in exemplary embodiments, the wheel regulator mechanism can include a manual lock that can restrict the rearward wheel(s) 110 such that they remain aligned to roll straight when going in reverse and/or forward.

In exemplary embodiments, forward wheel(s) 108 can freely and/or regulatedly swivel through forward swivel range “α” rolling in a first direction while rearward wheel(s) 110 can regulatedly swivel through rearward swivel range “β” rolling in a second direction while being regulated independently from the direction forward wheels(s) 110 roll through and/or without being regulated, for example, directly regulated, by the direction that the forward wheel(s) roll through.

Further, in exemplary embodiments, for an exemplary people mover 100 with more than one forward wheel(s) 108, each of forward wheel(s) 108 can freely and/or regulatedly swivel through different forward swivel range “α”. For example, a first front wheel 108 and a second front wheel 108 can roll in different directions. In exemplary embodiments, for an exemplary people mover 100 with more than one rearward wheel(s) 110, each of rearward wheel(s) 110 can regulatedly swivel through different rearward swivel range “β”. For example, a first rearward wheel 110 and a second rearward wheel 110 can roll in different directions.

Further still, in exemplary embodiments, for an exemplary people mover 100 with more than one forward wheel 108 and more than one reward wheel 110, each of forward wheel(s) 108 can freely and/or regulatedly swivel through different forward swivel range “α” while each of rearward wheel(s) 110 can regulatedly swivel through different rearward swivel range “β”. For example, a first front wheel 108, a second front wheel 108, a first rearward wheel 110, and a second rearward wheel 110 can each roll in different directions, three of the four wheels can roll in different directions, two of the four wheels can roll in different directions, and/or only one of the four wheels can roll in a different direction. This can lead to enhanced maneuverability of people mover 100.

In exemplary embodiments, forward wheel(s) 108 and/or rearward wheel(s) 110 can be any form of wheel, such as, but not limited to, an un-driven wheel, a driven wheel, a single wheel, double wheels, compound wheels, any combination and/or separation thereof, and/or any other reasonable wheel.

In exemplary embodiments, forward wheel(s) 108 and/or rearward wheel(s) 110 can be fabricated from any reasonable material, such as, but not limited to, rubber, plastic, nylon, any combination and/or separation thereof, and/or any other reasonable material.

In exemplary embodiments, first frame assembly 102, second frame assembly, 104, and/or any other element of people mover 100 can be fabricated from any reasonable material, such as, but not limited to, aluminum, stainless steel, fiber glass, carbon fiber, magnesium, titanium, any combination and/or separation thereof, and/or any other reasonable material.

Referring to FIG. 6, in exemplary embodiments, people mover 100 can be collapsible. This can be utilized to decrease the size of a space needed to store people mover 100. It will be understood that people over can use any technique to decrease the size of space needed to store people mover 100. For example, people mover 100 can include height adjusters 212 that can allow elements of people mover 100 to telescope. For another example, people mover 100 can other elements, such as, but not limited to hinged locations, bending joints, braking joints, quick release mechanisms, and/or any other mechanism capable of decreasing the size of space which people mover 100 can take up and/or be adjusted to. For yet another example, people mover 100 can include a plurality of pieces which can be connected and disconnected. For example, people mover 100 can break down into two or more pieces which can be connected and disconnected.

It will be understood that any of the steps described can be rearranged, separated, and/or combined without deviation from the scope of the invention. For ease, steps are, at times, presented sequentially. This is merely for ease and is in no way meant to be a limitation.

Further, it will be understood that any of the elements, and/or exemplary embodiments of the invention described can be rearranged, separated, and/or combined without deviated from the scope of the invention. For ease, various elements are described, at times, separately. This is merely for ease and is in no way meant to be a limitation.

While the various steps, elements, and/or exemplary embodiments of the invention have been outlined above, it is evident that many alternatives, modifications and variations will be apparent to those skilled in the art. The various steps, elements, and/or exemplary embodiments of the invention, as set forth above, are intended to be illustrative, not limiting. Various changes may be made without departing from the spirit and scope of the invention. Accordingly, the spirit and scope of the present invention is to be construed broadly and limited only by the appended claims and not by the foregoing specification.

What is claimed is:

1. A system for moving people, comprising:
a first frame assembly having a forward end, a rearward end, and a vertical riser;
a second frame assembly having a forward end, a rearward end, and a vertical riser;
a forward wheel coupled to the first frame assembly;
a first rearward wheel coupled to the first frame assembly;
a second rearward wheel coupled to the second frame assembly;
a width variator pivotably coupling the forward end of the first frame assembly and the forward end of the second frame assembly such that an offset distance between the rearward ends of the first frame assembly and the second frame assembly is adjustable;
a first rearward wheel regulator regulating the swivel range of the first rearward wheel;
a second rearward wheel regulator regulating the swivel range of the second rearward wheel;
wherein during adjustment of the offset distance between the rearward ends of the first frame-assembly and the second frame assembly, the first and the second rearward wheel regulators regulate the swivel of the rearward wheels such that people mover does not substantially traverse laterally.

2. The system for moving people of claim 1, wherein when the offset distance between the rearward ends of the first frame assembly and the second frame assembly is greatest distance, the first and the second rearward wheel regulators regulates the swivel of the rearward wheels such that the rearward wheels roll in a substantially forward direction or a substantially inwardly direction.

3. The system for moving people of claim 2, wherein the inwardly direction is any angle between 0 degrees to about 60 degrees inward from the forward direction.

4. The system for moving people of claim 1, wherein when the offset distance between the rearward ends of the first frame assembly and the second frame assembly is at its smallest the first and the second rearward wheel regulators regulate the swivel of the rearward wheels such that the rearward wheels can only roll in a substantially forward direction or a substantially outwardly direction.

5. The system for moving people of claim 4, wherein the outwardly direction is any angle between 0 degrees to about 60 degrees outward from the forward direction.

6. The system for moving people of claim 1, at least one of the rearward wheel regulators is a blocking pin, the blocking pin limiting the swivel of at least one of the rearward wheels by blocking rotation of the rearward wheels beyond a regulated angle.

7. The system for moving people of claim 1, wherein at least one of the rearward wheel regulators is an elastically deforming mechanism that limits the swivel range by elastically deformation hindering movement of at least one of the rearward wheels beyond a regulated swivel angle.

8. The system for moving people of claim 7, wherein the deforming mechanism is at least one of a spring, a bending member, or a compression member.

9. The system for moving people of claim 1, wherein at least one of the rearward wheel regulators, is a slot, a finger, or a groove that regulates the swivel range by hindering movement at least one of the rearward wheels beyond the at least one regulated swivel range.

10. The system for moving people of claim 1, further comprising:
a braking mechanism; and
an user interface including a braking mechanism interface and a supporting mechanism interface.

11. The system for moving people of claim 1, wherein the vertical riser further comprises:
a collapsing mechanism for decreasing the overall height of the system.

12. The system for moving people of claim 11, wherein the collapsing mechanism is a telescoping mechanism.

13. The system for moving people of claim 1, wherein each rearward wheel regulator further comprises:
a spring that restricts the rearward wheels such that they remained aligned to roll straight when rolling in reverse.

14. The system for moving people of claim 1, wherein the rearward wheel regulator further comprises:
a groove and channel that restricts the rearward wheels such that they remained aligned to roll straight when rolling in reverse.

15. The system for moving people of claim 1, wherein each of the rearward wheel regulators further comprises:
a manual lock that restricts the rearward wheels such that they remain aligned to roll straight when rolling in at least one of a reverse direction and forward direction.

16. The system for moving people of claim 1, wherein the first frame assembly further includes a horizontal runner and the second frame assembly further includes a horizontal runner.

17. The system of claim 10, wherein the braking mechanism locks the swivel of the rearward wheels.

18. The system of claim 1, wherein each of the rearward wheels is a castor wheel.

19. A system for moving people, comprising:
a first frame assembly having a forward end, a rearward end, and a vertical riser, the first frame assembly coupled to a forward wheel and a rearward wheel;
a second frame assembly having a forward end, a rearward end, and a vertical riser, the second frame assembly coupled to a forward wheel and a rearward wheel;
a width variator pivotably coupling the forward end of the first frame assembly to forward end of the second frame assembly such that offset distance between the rearward ends of the first frame assembly and the second frame assembly is adjustable; and
wherein the forward wheels are enabled to roll in any direction between 0 and 360 degrees, and the rearward wheels are enabled to roll in any direction outside of a restricted range of directions.

20. The system of claim 19, wherein the first frame assembly further includes a horizontal runner and the second frame assembly further includes a horizontal runner.
